(19) United States
(12) Patent Application Publication
(10) Pub. No.: US 2004/0129106 A1
(43) Pub. Date: Jul. 8, 2004

(54) Adjustable pedal

(76) Inventors: Jaume Terradas Prat, Barcelona (ES); David Gras Alonso, Barcelona (ES)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 10/338,365

(22) Filed: Jan. 8, 2003

(51) Int. Cl. G05G 1/14

(52) U.S. Cl. 74/512

(57) ABSTRACT

The present invention relates to an adjustable pedal, in particular for motor vehicles, by means of which the pedal foot, to be actuated, of the pedal is set optimally to the driver's size. During the adjustment of the pedal, the pedal foot is displaced parallel to the longitudinal axis of the vehicle. For this purpose, the adjustable pedal has a pedal and at least one subpedal and also a linkage adjustable by means of an actuator, the actuator changing the angular relationship between adjacent components of the linkage.

### PRIORITY

The present application claims priority under 35 USC §§ 119 and 365 to commonly owned and assigned Application No. PCT/EP01/08064 and German Application No. 100 33 703.1, both of which are entitled Adjustable Pedal and are incorporated herein by reference.

### FIELD OF THE INVENTION

The present invention relates to an adjustable pedal, by means of which the distance between the pedal and the user can be set optimally, without the functioning of the pedal being impaired. In particular, the present invention relates to a brake pedal, clutch pedal and accelerator pedal in a motor vehicle.

### BACKGROUND

In many areas of mechanics, such as, for example, in general mechanical engineering or in motor vehicle construction, there is a problem of providing the possibility of setting a pedal in a controlled manner, in such a way that it can be actuated optimally by the user. Particularly in motor vehicles, drivers of different size have the problem of coordinating their leg length with the position of the pedal. This has hitherto been made possible essentially by the seat adjustment. It has recently also been possible to adjust the position of the pedal to the driver's size by means of various technical solutions.

Additional safety elements, such as, for example, the airbag in the steering wheel, allow increased protection for the motor vehicle occupants in the event of an accident, provided that the driver is at the correct distance from the steering wheel. If, then, the optimal distance between the driver and the pedals is regulated via the setting of the seat position, the functioning of the airbag may thereby be impaired or even cancelled completely, since the driver's position in relation to the steering wheel also changes. For this reason, it is necessary for adjustable pedals to be used especially in motor vehicles.

The prior art provides various technical solutions for adjustable pedals. The simplest technical solution is described in U.S. Pat. No. 5,839,326. In this case, the pedal arm is designed in two parts, both parts of the pedal arm having long holes which overlap one another in their longitudinal direction. The length of the pedal arm can be adjusted to the driver's size, by means of the two long holes and a screw, by the continuous displacement of the two parts relative to one another. The technical solution presented here is very simple in design terms and can therefore be produced at a limited outlay. Its essential disadvantage, however, is that the pedal can be adjusted to the driver in each case only by the use of a tool. This fact is extremely inconvenient especially when there is a quick change of driver.

A further technical solution for adjustable pedals is offered by the publications WO 98/14857 and U.S. Pat. No. 5,819,593. Here, the pedal to be actuated is fastened displaceably on a shaft which extends parallel to the longitudinal axis of the vehicle. The pedal is displaced towards the driver or away from the driver along this shaft and is thereby adapted to his or her seat position or leg length. The displacement of the pedal takes place via electrical actuators which are actuated without the use of additional tools. It is thus possible for the pedal position to be adapted to the seat position of the respective driver in a simple way. However, the adjustment shaft of the pedal projects into the driver's area. Especially in the event of a front collision of the vehicle, this gives rise to an increased risk of injury to the driver, because the adjustment shaft is pressed into the driver's area by the vehicle chassis which undergoes deformation.

A further technical design for adjustable pedals is provided by EP 0 918 273 A1. In this case, the adjustable pedal is articulated rotatably on a lever which is pivotable via a gear and a servomotor. The adjustment of the pedal takes place by rotation about an axis of rotation. The pedals are pivoted towards the driver or away from the latter about this axis of rotation. This is a disadvantage, however, since the distance between the pedal foot and the vehicle floor increases or decreases. This fact is extremely inconvenient especially for small drivers who usually also have small feet. To be precise, in order to actuate the pedal reliably, the foot has to be raised and cannot be supported on the floor by the heel. The driver becomes fatigued and tense as a result. Furthermore, because it is composed of a motor, gear and complicated lever mechanism, this technical solution requires a considerable production outlay and subsequent maintenance which in each case incur unintended costs.

The adjustable pedal according to the publication U.S. Pat. No. 5,823,064 makes use of a lever mechanism essentially consisting of a pedal, of a subpedal and of an eccentric. The subpedal serves for the always identical actuation of the connecting member to, for example, the clutch system or brake system. The eccentric is used as an actuator, in order to rotate the pedal about its bearing axis and thus bring it into the position suitable for the driver. The distance between the pedal and the driver's foot is set by means of this design. As before, however, because of the rotational adjustment of the pedal the pedal foot is raised when the pedal is moved in the direction of the driver. This is unfavorable, as already described above.

A further technical solution for adjustable pedals is provided by the publication U.S. Pat. No. 5,855,143. In this case, the adjustable pedal is provided with the aid of a pedal and a subpedal which are connected adjustably to one another via a linking system. Two points of articulation of the linking system on the vehicle chassis are essential to the embodiment described. Using a suitable actuator in the linking system, the pedal rotates about one of the said points of articulation on the vehicle chassis and is adjusted in this way. This results, in a similar way to the embodiments described above, to an adjustment of the pedal which is parallel to the longitudinal axis of the vehicle and which is associated with an adjustment of the pedal height.

Further electrically adjustable pedal systems are discussed in U.S. Pat. No. 5,927,154 and U.S. Pat. No. 5,460,061.

The problem of the adjustable pedals provided by the prior art is that the distance between the pedal foot and the vehicle floor changes unfavorably during pedal adjustment. More precisely, the adjustment of the pedal in the direction of the driver, carried out hitherto, is associated with a simultaneous undesirable raising of the pedal. By contrast, adjustment of the pedal away from the driver results in an undesirable lowering of the pedal.

The problem on which the invention is based is therefore to provide adjustable pedals which, when being set to the driver's size, allow displacement in the longitudinal axis of the vehicle, the distance from the vehicle floor remaining constant. Furthermore, the technical implementation of the adjustable pedal is to be carried out preferably by means of a simple construction which consists of inexpensive materials, is capable of being executed in a modular design and can be installed, irrespective of the type of vehicle.

### SUMMARY OF THE INVENTION

Exemplary embodiments of the present invention that are shown in the drawings are summarized below. These and other embodiments are more fully described in the Detailed Description section. It is to be understood, however, that there is no intention to limit the invention to the forms described in this Summary of the Invention or in the Detailed Description. One skilled in the art can recognize that there are numerous modifications, equivalents and alternative constructions that fall within the spirit and scope of the invention as expressed in the claims.

The problem on which the invention is based is solved, according to the invention, by means of an adjustable pedal.

In particular, the problem on which the present invention is based is solved by means of an adjustable pedal, in particular for motor vehicles, which pedal has a pedal and at least one subpedal and also a linkage which is adjustable by means of an actuator and which connects the pedal and at least one subpedal directly to one another, the actuator changing the angular relationship between adjacent components of the linkage, and the pedal foot being at a predetermined distance from the vehicle floor during pedal adjustment.

An adjustable pedal in accordance with a preferred embodiment of the present invention is distinguished by a simple mechanical construction which can be adjusted, for example, by means of an electrical actuator. This simple construction allows the pedal to be adjusted away from the driver or towards the driver, essentially the distance between the pedal foot and vehicle floor remaining constant. The pedal foot is thereby adjusted, for example, at an average height relative to the vehicle floor and is adapted to large and small drivers. In the construction of the adjustable pedal, the height of the pedal foot is determined by means of the dimensioning of the linkage. The adjustable pedal according to the invention thus makes it possible for any driver to actuate it reliably and comfortably, whilst at the same time the safety requirements in the motor vehicle are taken into account.

Preferably, the linkage of the adjustable pedal consists of at least three components, the respective ends of the components being guided or rotatably fastened in a long hole, with the result that, during the movement of the actuator, the pedal executes a translational movement parallel to the longitudinal axis of the vehicle and a rotational movement about an axis of rotation.

The design of the adjustable linkage, in particular the arrangement of the centres of rotation and the shape of the guiding long holes, make it possible to adjust the pedal in a controlled manner at the predetermined height relative to the vehicle floor. Especially by means of the shape of the long holes and suitable positioning of the centres of rotation, a distance varying with the adjustment position can also be provided in addition to a constant distance between the pedal foot and vehicle floor.

According to other preferred embodiments of the adjustable pedal, the first subpedal is designed to be U-shaped in its one end region, the two legs having opposite holes for receiving the pedal bearing shaft. Furthermore, the first subpedal, in addition to a connection means, has either at least two long holes for receiving the ends of the U-shaped component of the linkage or at least one fastening point, in order to fasten the lever-like component for connection to the second subpedal.

The first subpedal provides for uniform transmission of the movement of the adjustable pedal to the brake system or clutch system or the like. For this purpose, the first subpedal is rotatably fastened with its end region to the pedal module. It is designed, furthermore, in such a way that it receives the respective ends of the adjustable linkage, so that the adjustable pedal can be suitably adjusted by means of the actuator.

According to another preferred embodiment of the adjustable pedal, the second subpedal consists of two L-shaped opposite components, the opposite ends of which are in each case connected by means of shafts, one shaft forming the axis of rotation of the second subpedal and the lever-like component for connection to the first subpedal being fastened to the other shaft.

A further embodiment of the adjustable pedal comprises two subpedals which allow the suitable adjustment of the adjustable pedal. The use of two rotatably fastened subpedals may be preferred, depending on the configuration of the pedal module or of the vehicle chassis. In this case, the movement of the adjustable pedal is transmitted to the respective systems via the second subpedal and the first subpedal.

Preferably, in order to adjust the adjustable pedal an actuator is used which is fastened as a linear actuator to the first subpedal or as a rotating actuator to a lever-like component of the linkage.

The adjustable pedal is preferably adjusted by means of electrical actuators. This allows a convenient and quick adjustment of the pedal position to the driver. Depending on the type of articulation of the actuator on the adjustable pedal, various types of actuators based, for example, on a rotational movement or a translational movement are possible.

Furthermore, an embodiment of the present invention provides an adjustable pedal, in particular for motor vehicles, which has a pedal fastened to a fastening means and a holding means and also a linkage which is adjustable by means of an actuator and which connects the fastening means and the holding means directly to one another, the actuator changing the angular relationship between adjacent components of the linkage. This adjustable pedal is suitable preferably for the actuation of the electrical actuating elements, such as, for example, the accelerator pedal in a motor vehicle.

Another embodiment of the present invention provides a further embodiment of an adjustable pedal, in which, using an adjustable linkage, the pedal holding means and therefore the entire pedal are adjusted. This embodiment according to the invention is suitable particularly for pedals which have no mechanical coupling elements to other systems, such as, for example, the brake system.

Another embodiment of the adjustable pedal is characterized by a linkage comprising at least four lever-like components, of which two in each case are connected to one another in a scissor-like manner, in each case the first ends of the components being guided in a long hole and in each case the other ends being fastened rotatably, with the result that, during the movement of the actuator, the pedal executes a translational movement parallel to the longitudinal axis of the vehicle and a rotational movement about an axis of rotation.

The suitable articulation and dimensioning of the adjustable linkage make it possible to adapt the pedal position to the driver. A predetermined adjustment travel of the adjustable pedal is fixed as a function of the positioning of the centres of rotation and of the shape of the long holes. In this case, the distance between the pedal foot and vehicle floor can remain constant or vary.

Furthermore, the adjustable pedal may comprise a linear actuator which is fastened to the holding means, the actuator displacing a connecting element of the linkage, the said connecting element connecting two opposite ends of lever-like components.

As previously stated, the above-described embodiments and implementations are for illustration purposes only. Numerous other embodiments, implementations, and details of the invention are easily recognized by those of skill in the art from the following descriptions and claims.

### BRIEF DESCRIPTION OF THE DRAWINGS

Embodiments of the present invention which are preferred at the present time are explained in more detail with the aid of the drawings and the following detailed description. In the drawings:

FIG. 1 shows a general illustration of a pedal module for motor vehicles, comprising an adjustable clutch pedal, an adjustable brake pedal and an adjustable accelerator pedal, in each case corresponding to the preferred embodiment of the present invention;

FIG. 2 shows an illustration of an adjustable pedal according to a first preferred embodiment of the present invention;

FIG. 3 shows an illustration of a first preferred embodiment of the present invention in a side view, two different adjustment positions of the adjustable pedal according to the invention being shown;

FIG. 4 shows a second embodiment, preferred according to the invention, of an adjustable pedal according to the present invention;

FIG. 5 shows a second embodiment, preferred according to the invention, of the adjustable pedal according to the present invention in a side view, two different adjustment positions of the adjustable pedal being shown;

FIG. 6 shows a third embodiment, preferred according to the invention, of an adjustable pedal according to the present invention, consisting of a pedal, of a fastening means, of a holding means and of a linkage; and

FIG. 7 shows a third embodiment, preferred according to the invention, of an adjustable pedal according to the present invention, two different adjustment positions of the adjustable pedal being shown.

The preferred embodiments of the invention are explained in detail below with reference to the drawings.

### DETAILED DESCRIPTION

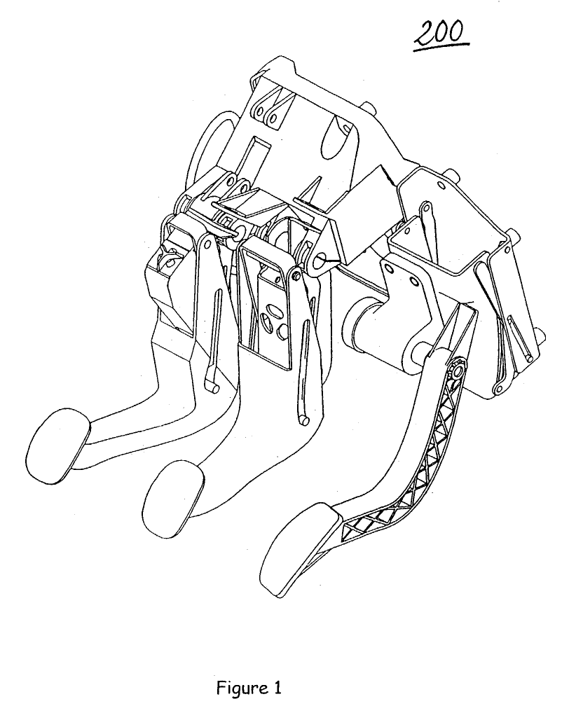

Motor vehicles are nowadays being produced to an increased extent in a modular design. This means that specific modules, such as, for example, the pedal module, are manufactured, irrespective of the type of vehicle, and are subsequently installed in the respective motor vehicle. Such a pedal module 200 mentioned above is shown in FIG. 1.

Preferably, according to various embodiments of the invention, this pedal module is composed of three adjustable pedals which form the brake pedal, clutch pedal and accelerator pedal of a motor vehicle. Furthermore, however, it is also possible for adjustable pedals to be installed individually rather than in a modular design, in motor vehicles, machines or the like.

Preferably, the adjustable pedals are manufactured from plastics, such as, for example, polyamide, which, if necessary, are supplemented by additional reinforcing elements. It is also possible, however, to manufacture the adjustable pedals from any other desired materials, as long as they satisfy the technical application requirements.

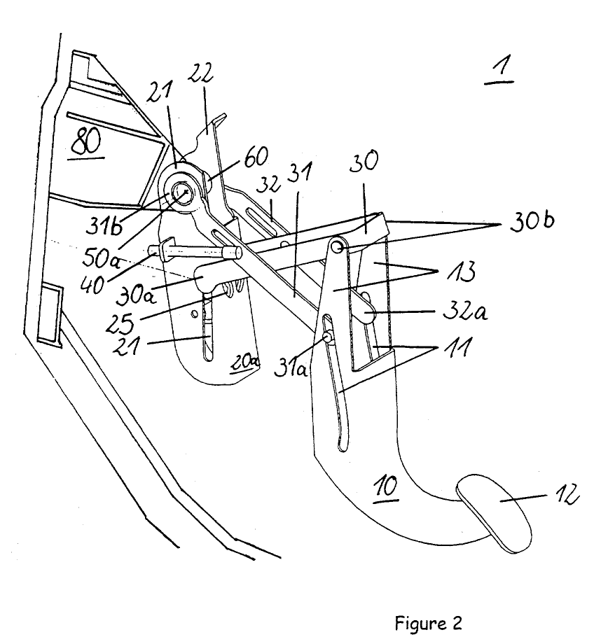

Various embodiments, preferred according to the invention, of adjustable pedals are explained below with reference to the drawing. FIG. 2 shows a first preferred embodiment of an adjustable pedal which is composed of a pedal 10, of a subpedal 20a, of an adjustable linkage 30, 31, 32 and of an actuator 40. The pedal 10 and the subpedal 20a are connected directly to one another by the adjustable linkage 30, 31, 32. The linear actuator 40 is fastened to the subpedal 20a and engages on the adjustable linkage 30, 31, 32 in such a way that the distance between the pedal 10 and subpedal 20a is varied by means of the change in length of the actuator 40.

The adjustable linkage 30, 31, 32 is composed of a U-shaped lever 30 and of two levers 31, 32 fastened rotatably to the legs of the U-shaped lever 30 in a scissor-like manner. The levers 31, 32 have, in their longitudinal direction, a long hole, in which one end of the actuator is guided. Furthermore, preferably, the first ends 31a, 32a of the levers 31, 32 have projections, by means of which they are guided in the long holes 11 of the pedal 10. Suitable orifices are formed at the second ends 31b, 32b of the levers 31, 32, in order to fasten the levers 31, 32 to the pedal bearing shaft 60. The U-shaped lever 30 of the adjustable linkage 30, 31, 32 has, at its ends 30a, projections which point into the inner region of the U-shaped lever 30 and are guided in the long holes 21 of the subpedal 20a. Furthermore, the U-shaped lever 30 has, near the connection of the two legs, two opposite centres of rotation 30b, at which the pedal 10 is fastened rotatably.

Preferably, the first embodiment of the adjustable pedal 1 has a subpedal 20a which is fastened to the pedal module 80 rotatably via the pedal bearing shaft 60. It is also possible, however, for the subpedal 20a to be directly fastened rotatably to the vehicle chassis. The upper end region of the subpedal 20a is of U-shaped design, the opposite legs 21, 22 having likewise opposite holes for receiving the pedal bearing shaft 60. Furthermore, preferably, the subpedal 20a has connection means 25, via which it can be connected, for example, to the clutch system or to the brake system of a motor vehicle. Moreover, symmetrically arranged long holes 21, already mentioned above, extend on both sides in the second end region 20a, run approximately in the longitudinal direction of the subpedal 20a and receive the projections of the ends 30a of the U-shaped lever 30.

Moreover, the linear actuator 40 is fastened to the subpedal 20a, so that the actuator can engage into one of the long holes of the levers 31, 32 of the adjustable linkage 30, 31, 32, in order thereby, as a result of the variation in its length, to place the subpedal 20a and the pedal 10 at a distance from one another. It is also possible, of course, to fasten the actuator 40 at any other desired point on the subpedal 20a or within the adjustable linkage 30, 31, 32 and also to design the said actuator as a non-linear actuator, in order to perform the function of the adjustable pedal.

The pedal 10 has an end region which terminates in a U-shaped manner and the opposite legs 13 of which are fastened rotatably to the U-shaped lever 30 at the centres of rotation 30b. Furthermore, preferably, long holes 11 run in the middle region of the pedal 10 and receive and guide the projections 31a and 32a of the levers 31 and 32 of the adjustable linkage 30, 31, 32. That end region of the pedal 10 which is located opposite the U-shaped end region is bent in an L-shaped manner and has a pedal foot 12 for the actuation of the adjustable pedal 1.

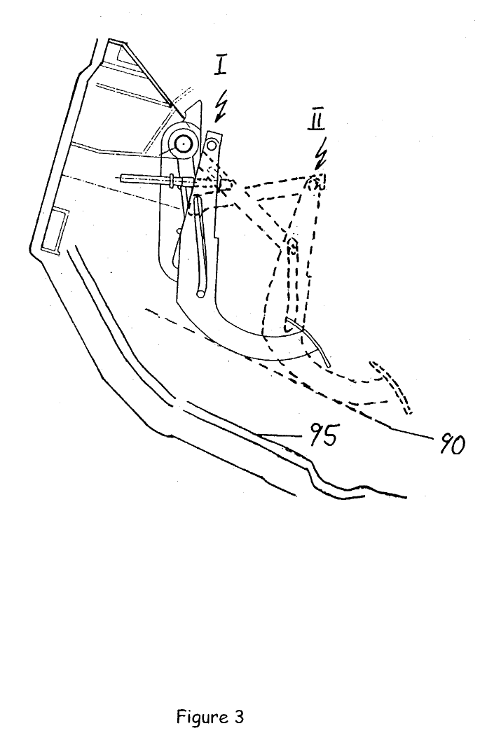

The illustration in FIG. 3 shows diagrammatically the adjustment of the adjustable pedal. In a first adjustment position of the adjustable pedal 1, identified by 1 and unbroken lines, the scissor-like regions of the adjustable linkage 30, 31, 32 are open to the greatest possible extent. Furthermore, the ends 30a of the U-shaped lever 30 are located at the lower end of the long holes 21 of the subpedal 20a and the ends 31a and 32a of the levers 31 and 32 are located at that end of the long holes 11 of the pedal 10 which faces the pedal foot 12. As a result of the deflection of the actuator 40, the scissor-like regions of the adjustable linkage 30, 31, 32 are increasingly closed and the pedal 10 is thereby placed at a distance from the subpedal 20a. By virtue of this movement of the actuator 40, the ends of the adjustable linkage 30, 31, 32 which are guided in the long holes 21 and 11 move into the upper region of the subpedal 20 and of the pedal 10. Due to the deflection of the actuator 40, the pedal 10 is displaced along the broken line 90. This movement, executed essentially as a translational movement, displaces the pedal 10, and the pressure region 12 important for actuating the pedal, parallel to the longitudinal axis of the vehicle and simultaneously executes a variation in height relative to the motor vehicle floor 95. At the same time, during the movement of the pedal 10 towards the driver, the pressure region 12 is lowered. During the movement of the pedal 10 away from the driver, the pressure region 12 is correspondingly raised. The pedal position is thereby adjusted optimally to the driver in terms of height and distance.

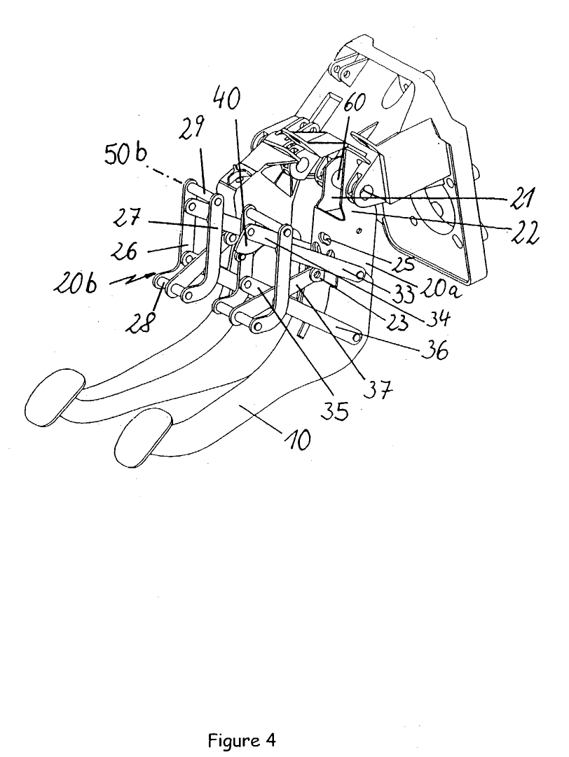

A second preferred embodiment of the adjustable pedal 1 of the present invention is shown in FIG. 4. Preferably, the adjustable pedal 1 consists of a pedal 10, of two subpedals 20a and 20b, of a linkage 33, 34, 35, 36, 37 and of an actuator 40. The first subpedal 20a has, in a similar way to the first preferred embodiment of, the present invention, a U-shaped end region with legs 21 and 22, in which opposite holes for receiving the pedal bearing shaft 60 are located. Furthermore, preferably, subpedal 20a has a connection means 25 which serves for connection to further systems to be actuated. Possible examples of such systems are the brake system or clutch system. By means of a lug 23 fastened to the subpedal 20a or as a result of a suitable fastening facility taking a different form, the first subpedal 20a is connected to the second subpedal 20b via the lever-like component 37 of the adjustable linkage 33, 34, 35, 36, 37. The connection via the lever-like component 37 allows the transmission of force between the first subpedal 20a and the second subpedal 20b.

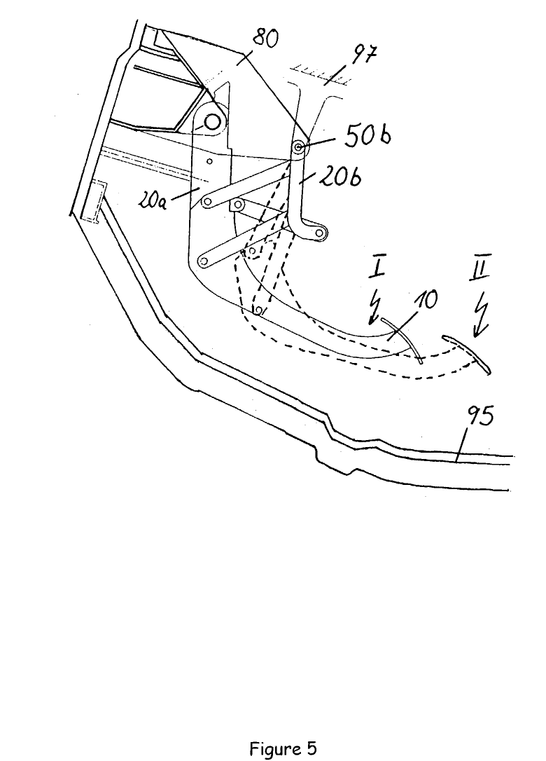

The second subpedal 20b is fastened (see FIG. 5) rotatably either to the pedal module 80 or to the motor vehicle chassis 97. Furthermore, preferably, the second subpedal 20 consists of two opposite L-shaped components 26, 27, the ends of which are connected by means of shafts 28, 29. The upper shaft 29 of the second subpedal 20b, the said shaft also serving for the rotatable fastening of the second subpedal 20b to the pedal module 80 or to the motor vehicle chassis 97, defines a subpedal axis of rotation 50b. The second subpedal 20b is connected directly to the pedal 10 via an adjustable linkage 33, 34, 35, 36. The adjustable linkage 33, 34, 35, 36 is composed of lever-like components 33, 34, 35, 36, the first end of which is fastened rotatably to the pedal 10 and the second end of which is fastened rotatably to the subpedal 20b. Via a rotating actuator 40, which is fastened to the lever-like component 34, the linkage 33, 34, 35, 36 can be adjusted in such a way that the pedal 10 is placed at a distance from the first subpedal 20a and is adapted optimally to the driver's foot position.

FIG. 5 describes, by means of a diagrammatic illustration, how the adjustable pedal 1 according to a second preferred embodiment of the present invention is adjusted from a first adjustment position, identified by unbroken lines, into a second adjustment position, identified by broken lines. As a result of the actuation of the actuator 40 (not shown here), the pedal 10 is placed at a distance from the first subpedal 20a as a result of a translational movement parallel to the longitudinal axis of the vehicle and as the result of a rotational movement about the pedal axis of rotation 50b of the second subpedal 20b. If, in this case, the adjustable pedal 1 is adapted to the foot position of a driver of small body size, which here corresponds to the broken-line illustration, both the pedal 10 is displaced in the direction of the driver and its height relative to the motor vehicle floor 95 is reduced. The pedal position is thereby adjusted optimally to the driver's respective foot position with the aid of the adjustable pedal 1.

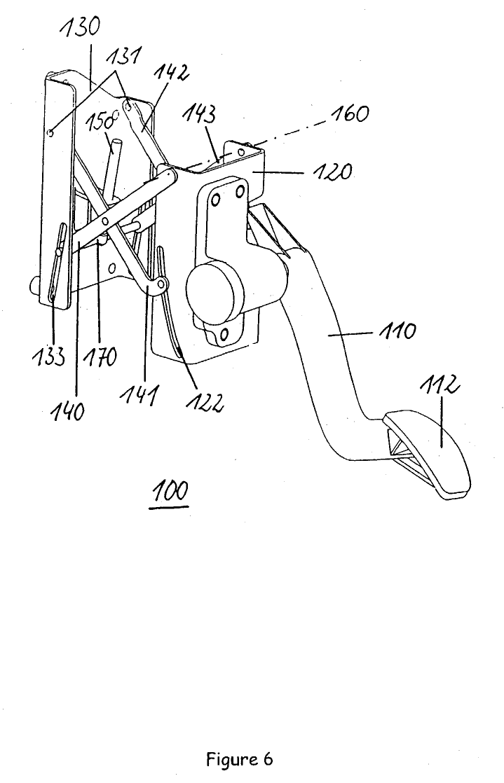

FIG. 6 gives an illustration of a third preferred embodiment of an adjustable pedal 100 of the present invention. This adjustable pedal 100 serves, for example, for the actuation of electrical systems. This applies, for example, to accelerator pedals in motor vehicles which are actuated via a potentiometer.

The adjustable pedal 100 is composed of a pedal 110, of a fastening means 120, of a holding means 130 and of an adjustable linkage 140, 141, 142, 143. The pedal 110 is fastened rotatably to the fastening means 120. The fastening means 120 is formed, in this case, by a sheet-like U-shaped profile. At the upper end of the fastening means 120, an axis of rotation 160 is defined by opposite centres of rotation of the adjustable linkage 140, 141, 142, 143 which are positioned on the legs of the U-shaped profile. In the lower half of the fastening means 120, long holes 122 are introduced in the leg regions of the U-shaped profile and run approximately in the longitudinal direction of the fastening means 120. They serve for receiving and guiding the ends of the lever-like components 141 of the adjustable linkage 140, 141, 142, 143.

Preferably, the holding means 130 is likewise formed by a sheet-like U-shaped profile, the legs of the U-profile pointing in the direction of the fastening means 120. The holding means 130 serves for fastening the adjustable pedal 100 to the pedal module or to the vehicle chassis (not shown). Furthermore, the holding means 130, in its upper region, provides on the legs the centres of rotation 131, in each case opposite one another, for the lever-like components 141 and 142 of the adjustable linkage 140, 141, 142, 143. Long holes 133 are made opposite one another on the legs in the lower region of the holding means 130, the said long holes running essentially in the direction of the longitudinal axis of the holding means 130 and serving for receiving the ends of the lever-like components 140 and 143 of the adjustable linkage 140, 141, 142, 143. Furthermore, preferably, the holding means 130 has fastened to it an actuator 150, by means of the change in length of which the adjustable linkage 140, 141, 142, 143 is adjusted. The actuator 150 is coupled to a connecting component 170 which connects the two ends of the lever-like components 140 and 143 of the adjustable linkage 140, 141, 142, 143, the said ends being guided in the long holes 133 of the holding means 130.

The scissor-like adjustable linkage 140, 141, 142, 143 consists of four lever-like components 140, 141, 142, 143, the lever-like components 140, 141 and 142, 143 being connected to one another in a scissor-like manner via a centre of rotation. Furthermore, preferably, the lever-like components 141 and 142 are of L-shaped design, one end being connected rotatably to the legs of the U-shaped holding means 130 and the other end being guided in the long hole 122 of the fastening means 120. One end of the lever-like components 140 and 143 is guided in long holes 133 of the U-shaped holding means 130, whilst the other end is fastened rotatably to the legs of the U-shaped fastening means 120.

As a result of the displacement of the connecting component 170 via the actuator 150, the scissor-like adjustable linkage 140, 141, 142, 143 is opened or closed, and the distance between the fastening means 120 and holding means 130 is varied in this way. By virtue of the shape of the long holes 133 in the holding means 130 and of the long holes 122 in the fastening means 120, the distance between the holding means 130 and the fastening means 120 is varied due to the movement of the actuator 150, and the pedal position is thereby set optimally. In this case, the movement of the fastening means 120 may be composed of a translational movement and of a rotational movement.

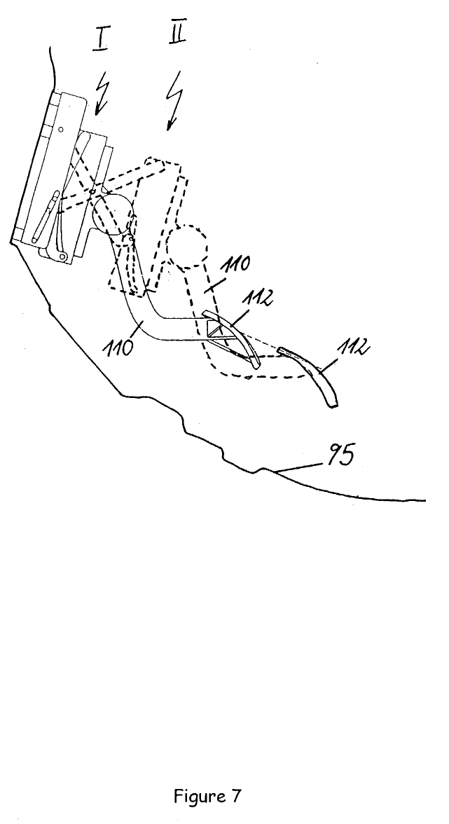

FIG. 7 gives a diagrammatical illustration of the third preferred embodiment of the adjustable pedal 100 according to the present invention in a first adjustment position, illustrated by unbroken lines, and in a second adjustment position, illustrated by broken lines. In a similar way to the first and second embodiments of the present invention which have already been explained in detail, when the adjustment position of the adjustable pedal 100 is varied both the distance between the pedal 10 and the driver and the height of the pedal foot 112 are set optimally.

With the aid of the preferred embodiment, described in detail, of the present invention, it is possible, for example, to build up a pedal module for motor vehicles which consists of an adjustable clutch pedal, of an adjustable brake pedal and of an adjustable accelerator pedal. In this way, the pedal position can be adjusted to the foot position of any driver, with the result that, on the one hand, comfort is increased and, on the other hand, the motor vehicle satisfies more stringent safety requirements. It is also possible, however, to use the adjustable pedal 1, 100 according to the invention in other areas in which an adjustable pedal assembly is necessary for the actuation of various systems.

List of reference symbols

| | |
|---|---|
| 1, 100 | Adjustable pedal |
| 10, 110 | Pedal |
| 11 | Long holes in the pedal 10 |
| 12, 112 | Pedal foot |
| 20a, 20b | Subpedal |
| 21 | Long holes in the subpedal 20a |
| 23 | Lug |
| 25 | Connection means |
| 26, 27 | L-shaped components |
| 28, 29 | Shafts |
| 30, 31, 32 | Adjustable linkage |
| 33, 34, 35, 36, 37 | Adjustable linkage |
| 30 | U-shaped lever |
| 30a | Ends of the U-shaped lever |
| 30b | Centres of rotation of the pedal 10 |
| | on the U-shaped lever 30 |
| 31, 32 | Levers |
| 31a, 32a | First end of the levers 31, 32 |
| 31b, 32b | Second end of the levers 31, 32 |
| 33, 34, 35, 36, 37 | Lever-like components |
| 40 | Actuator |
| 50a, 50b | Subpedal axis of rotation |
| 60 | Pedal bearing shaft |
| 80 | Pedal module |
| 90 | Adjustment line of the pedal 10 |
| 95 | Motor vehicle floor |
| 97 | Motor vehicle chassis |
| 120 | Fastening means |
| 130 | Holding means |
| 140, 141, 142, 143 | Adjustable linkage |
| 140, 141, 142, 143 | Lever-like components |
| 150 | Actuator |
| 170 | Connecting component |
| 200 | Pedal module |
| I | First adjustment position |
| II | Second adjustment position |

Those skilled in the art can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. An adjustable pedal comprising:
a. a pedal with a pedal foot and with at least one subpedal;
b. a linkage which is adjust able by means of an actuator and which connects the pedal and the at least one subpedal directly to one another,
c. the actuator changing the angular relationship between adjacent components of the linkage, and, during pedal adjustment, the pedal foot being at a predetermined distance from the vehicle floor.

2. The adjustable pedal according to claim 1, wherein, during pedal adjustment, the distance between the pedal foot and vehicle floor remains constant.

3. The adjustable pedal according to claim 1, wherein the linkage comprises at least three components, the respective ends of the components being guided or rotatably fastened in a long hole, with the result that, during the movement of the actuator, the pedal executes a translational movement parallel to the longitudinal axis of the vehicle and a rotational movement about an axis of rotation.

4. The adjustable pedal according to claim 2, wherein the linkage comprises at least three components, the respective ends of the components being guided or rotatably fastened in a long hole, with the result that, during the movement of the actuator, the pedal executes a translational movement parallel to the longitudinal axis of the vehicle and a rotational movement about an axis of rotation.

5. The adjustable pedal according to claim 3, wherein the linkage has:
a. a U-shaped lever, the ends of which are guided in long holes of the subpedal, and two levers fastened rotatably in a scissor-like manner to the legs of the U-shaped lever, the levers each having a long hold for receiving one end of the actuator, their first end being guided in a long hole of the pedal and their second end being articulated on the pedal bearing shaft; or
b. four lever-like components, the first end of which is fastened rotatably to the pedal and the second end of which is fastened rotatably to the second subpedal, a lever-like component making a connection between the first subpedal and the second subpedal.

6. The adjustable pedal according to claim 3, wherein those ends of the components of the linkage which are guided in long holes have projections which engage into the respective long holes.

7. The adjustable pedal according to claim 4, wherein those ends of the components of the linkage which are guided in long holes have projections which engage into the respective long holes.

8. The adjustable pedal according to claim 1, wherein the first subpedal has a U-shaped design in its one end region, the two legs having opposite holes for receiving the pedal bearing shaft.

9. The adjustable pedal according to claim 8, wherein the first subpedal, in addition to a connection means, has:
a. at least two long holes for receiving the ends of the U-shaped component of the linkage; or
b. at least one fastening point, in order to fasten the lever-like component for connection to the second subpedal.

10. The adjustable pedal according to claim 1, wherein the second subpedal consists of two L-shaped opposite components, the opposite ends of which are in each case connected by means of shafts, one shaft forming the axis of rotation of the second subpedal and the lever-like component for connection to the first subpedal being fastened to the other shaft.

11. The adjustable pedal according to claim 1, wherein the actuator is fastened as a linear actuator to the first subpedal or as a rotating actuator to a lever-like component of the linkage.

12. An adjustable pedal comprising:
a. a pedal fastened to a fastening means and holding means;
b. a linkage which is adjustable by means of an actuator and which connects the fastening means and the holding means directly to one another,
c. the actuator changing the angular relationship between adjacent components of the linkage, and, during pedal adjustment, the pedal foot being at a predetermined distance from the vehicle floor.

13. The adjustable pedal according to claim 12, wherein, during pedal adjustment, the distance between the pedal foot and vehicle floor remains constant.

14. The adjustable pedal according to claim 12, wherein the linkage comprises at least four lever-like components, of which two in each case are connected to one another in a scissor-like manner, in each case the first ends of the components being guided in a long hole and in each case the other ends being fastened rotatably, with the result that, during the movement of the actuator, the pedal executes a translational movement parallel to the longitudinal axis of the vehicle and a rotational movement about an axis of rotation.

15. The adjustable pedal according to claim 13, wherein the linkage comprises at least four lever-like components, of which two in each case are connected to one another in a scissor-like manner, in each case the first ends of the components being guided in a long hole and in each case the other ends being fastened rotatably, with the result that, during the movement of the actuator, the pedal executes a translational movement parallel to the longitudinal axis of the vehicle and a rotational movement about an axis of rotation.

16. The adjustable pedal according to claim 12, wherein the actuator is a linear actuator and is fastened to the holding means.

17. The adjustable pedal according to claim 16, wherein the actuator displaces a connecting element of the linkage, the said connecting element connecting two opposite ends of lever-like components.
